(19) United States
(12) Patent Application Publication
(10) Pub. No.: US 2018/0240073 A1
(43) Pub. Date: Aug. 23, 2018

(54) System to Hire, Maintain, and Predict Elements of Employees, and Method Thereof

(71) Applicant: Daniel Joseph Olsher, Arlington, VA (US)

(72) Inventor: Daniel Joseph Olsher, Arlington, VA (US)

(21) Appl. No.: 15/892,333

(22) Filed: Feb. 8, 2018

Related U.S. Application Data
(60) Provisional application No. 62/460,780, filed on Feb. 18, 2017.

(51) Int. Cl. G06Q 10/10; G06N 5/02

(52) U.S. Cl. CPC G06Q 10/1053; G06N 5/022

(57) ABSTRACT

A system to predict whether a candidate is a compatible hire for an entity, the system including a server to store first data corresponding to business characteristics of the entity and second data corresponding to job roles of the entity, and an apparatus to receive third data corresponding to the candidate and to transmit the third data to the server, such that the server analyzes the third data based on a subset of data comprising at least a portion of the first data merged with at least a portion of the second data, and the server outputs a prediction as to whether the candidate is a compatible hire for the company based on the analysis.

### CROSS REFERENCE TO RELATED APPLICATIONS

This application claims the benefit of U.S. Provisional Patent Application No. 62/460,780, filed Feb. 18, 2017 and entitled “SYSTEM TO HIRE, MAINTAIN, AND PREDICT ELEMENTS OF EMPLOYEES, AND METHOD THEREOF” the entire disclosure of which is incorporated herein by reference.

### BACKGROUND OF THE INVENTION

### 1. Field of the Invention

The present general inventive concept relates generally to system and method to aid in hiring and maintaining employees.

### 2. Description of the Related Art

Conventional methods of employee hiring/business prediction have been too formulaic or ad-hoc to fully reflect the complex interplay between the contexts and needs of Hirers and the personalities, backgrounds, and contexts of potential candidates. In some cases, reviewing a candidate's resume and grades often causes potentially perfect candidates to be overlooked, while giving only candidates that “look good on paper” a chance, despite the likelihood of long-term success.

Also, conventional hiring is primarily subjective in nature, time-consuming, and tedious, and oftentimes, interviews are scheduled for candidates that are solely based on resumes and academic credentials, which often do NOT illustrate a candidate's full fit.

These methods do not consider the candidate in the full context of the company's culture, customers, markets, and other attributes. As such, even employees that performed well during the interview may not be a match for the company in the long-run, resulting in sub-par performance, customer dissatisfaction, mission failure, company loss of profit, and eventually firing/lay-offs. Moreover, employees that may be performing well in their current position may in fact be improperly utilized and thus more likely to leave, resulting in further company losses due to attrition.

Therefore, there is a need for a multi-faceted method for combining nuanced subjective and objective data and information in an algorithm and system to match ideal employees with Hirers based on corporate culture, employee experience, professional attitude, personality profiles, work-ethic, typical customer worldviews, critical attributes of Hirer process and products, and other difficult-to-consider criteria.

Also, there is a need for a method of using collected information about companies and employees to simulate the worldviews and opinions of those employees, determine who may be at risk, and automatically suggest interventions that may help ameliorate the situation.

Finally, there is a need for a system and process that will help Hirers hire ideal candidates for specific roles/positions, thereby preventing overall losses in time and resources while increasing profitability and mission success.

### SUMMARY

The present general inventive concept provides a system and method to aid in hiring and maintaining employees.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system to predict whether a candidate is a compatible hire for an entity, the system including a server to store first data corresponding to business characteristics of the entity and second data corresponding to job roles of the entity, and an apparatus to receive third data corresponding to the candidate and to transmit the third data to the server, such that the server analyzes the third data based on a subset of data comprising at least a portion of the first data merged with at least a portion of the second data, and the server outputs a prediction as to whether the candidate is a compatible hire for the company based on the analysis.

The apparatus may further include an input unit to allow a user to input the third data, and a display unit to display the prediction to the user.

The apparatus may further include a communication unit to transmit the third data to and from the server.

The user may input the first data and the second data via the input unit to allow the communication unit to transmit the first data and the second data to the server.

The input unit may include at least one of a keyboard, a touchpad, a mouse, a trackball, a stylus, a voice recognition unit, a visual data reader, a camera, a wireless device reader, and a holographic input unit.

The communication unit may include a device capable of wireless or wired communication between other wireless or wired devices via at least one of Wi-fi direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The server may store the third data.

The server may analyze another subset of data comprising at least a portion of the first data merged with at least a portion of the second data and at least a portion of the third data, and outputs a letter of rejection or a letter of acceptance based on the analysis of the another subset of data.

The server may generate a questionnaire based on the subset of data to allow the candidate to input answers into the questionnaire to be merged with the third data.

The server may generate a job description based on the subset of data.

When the candidate is a hired employee, the server may output risk data to indicate that action should be taken to alleviate any risks associated with the candidate.

The third data may be based on at least one of information input by a user and other information autonomously retrieved by the processor.

The foregoing and/or other features and utilities of the present general inventive concept may also be achieved by providing a server to predict whether a candidate is a compatible hire for a company, the server including a storage unit to store first data corresponding to business characteristics of the company, second data corresponding to job roles of the company, and third data corresponding to the candidate, and a processor to analyze the third data based on a subset of data comprising at least a portion of the first data merged with at least a portion of the second data, and to output a prediction as to whether the candidate is a compatible hire for the company based on the analysis.

The third data may be based on at least one of information input by a user and other information autonomously retrieved by the processor.

The foregoing and/or other features and utilities of the present general inventive concept may also be achieved by providing a server to determine whether an employee of a company is at risk, the system including a storage unit to store at least one set of data, and a processor to analyze the set of data based on at least one of predetermined criteria, generated criteria, and retrieved criteria to determine whether the employee is considered to be at risk.

The predetermined criteria may include at least one of a level of engagement of the employee in the company, an emotional state of the employee, likelihood of the employee leaving the company, likelihood of the employee creating security threats, whether the employee is happy in a current position, whether the employee is thinking about quitting, whether the employee is bored, and whether the employee feels safe at work.

The at least one set of data may be based on at least one of information input by a user and other information autonomously retrieved by the processor.

The foregoing and/or other features and utilities of the present general inventive concept may also be achieved by providing a method of predicting whether a candidate is a compatible hire for a company, the method including storing first data in a storage unit of a server, the first data corresponding to business characteristics of the company, storing second data in the storage unit of the server, the second data corresponding to job roles of the company, receiving third data in the server, the third data corresponding to the candidate, analyzing the third data based on a subset of data comprising at least a portion of the first data merged with at least a portion of the second data, and outputting a prediction as to whether the candidate is a compatible hire for the company based on the analysis.

The foregoing and/or other features and utilities of the present general inventive concept may also be achieved by providing a method of determining whether an employee of a company is at risk, the method including storing at least one set of data, and analyzing the set of data based on at least one of predetermined criteria, generated criteria, and retrieved criteria, to determine whether the employee is considered to be at risk.

The foregoing and/or other features and utilities of the present general inventive concept may also be achieved by providing a system to predict whether a candidate is a compatible hire for a company, the system including a storage unit to store at least one set of data, and a processor to analyze the set of data based on at least one of predetermined criteria, generated criteria, and retrieved criteria, to determine whether the employee is considered to be a compatible hire for the company.

The at least one set of data is based on at least one of information input by a user and other information autonomously retrieved by the processor.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a system to hire, maintain, and predict elements of employees, according to an exemplary embodiment of the present general inventive concept; and

FIG. 2 illustrates a server to hire, maintain, and predict elements of employees, according to another exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### DEFINITIONS

Hiring Support Tool (HST)—This is a software that is run and accessed by the system of the present general inventive concept, in order to facilitate optimal hiring and maintenance of employees. The HST may be deployed in the various modes, including, but not limited to:

a) Software as a Service (SaaS) Mode—This mode of deploying the HST is directed to the software running on servers and other infrastructures that are controlled by an administrator, and the user may access it via a Web-based browser interface and/or local client that is installed on a machine to access the system.

b) On Premise (OP) Mode—This mode of deploying the HST is directed to the software running on the customer's own infrastructure, generally with support. As in the SaaS mode, the user may access it via a Web-based browser interface and/or local client that is installed on a machine to access the system.

MindMap Database (MMDB)—Stores the general Mind Maps (including those of the Hirer and all other domain knowledge) necessary to support the simulations that the HST runs (described below as business characteristics of a company).

Candidate Database (CDB)—Stores information (CVs, test scores, interview-derived data, simulation outputs, etc.) for potential candidates for jobs.

Role Database (RDB)—Stores information about the various roles the Hirers can use the system to hire for, including Job Descriptions (JD), data on specific requirements, data regarding psychological aspects that make a candidate successful in that role, etc.

System Dashboard (SDa)—Main interface that Hirers use to interact with the HST. In two preferred embodiments, i.e., in both SaaS and OP deployment modes, this can be delivered as a Web-based application or as a software tool that the user can install on and view on a local system.

Company—Here, although the present general inventive concept refers to the term “company,” in actuality, any type of “entity” that has employees, volunteers, groups, or other types of individuals could utilize the system described herein.

Entity—An “entity” may include a government agency, a school, a business, a church, a farm, or any other type of entity.

Exemplary Goal of the Present General Inventive Concept

One goal of The Present General Inventive Concept One goal and/or purpose of the present general inventive concept is to help companies and governments (i.e., Hirers) discover exactly who to hire and why (and, of course, who not to hire and why). This may be achieved by:

a) understanding details behind an impact that hiring a particular candidate will make for the Hirers;

b) simulating an impact/fit of individual potential candidates and making recommendations, and

c) facilitating the Hirers' decision processes.

Another Exemplary Goal of the Present General Inventive Concept

Another exemplary goal of the present general inventive concept is to use company and personnel information to predict elements of employee behavior and engagement.

As such, the present general inventive concept enhances hiring and business/security prediction by gathering in-depth Mind Maps about all participants, combining these Mind Maps with relevant domain and psychological knowledge, simulating the fit of a potential candidate in real-time, and making recommendations (with clear explanations). As such, outputs of these simulations/recommendations are accessible to Hirers via clear and easy-to-use graphical interfaces.

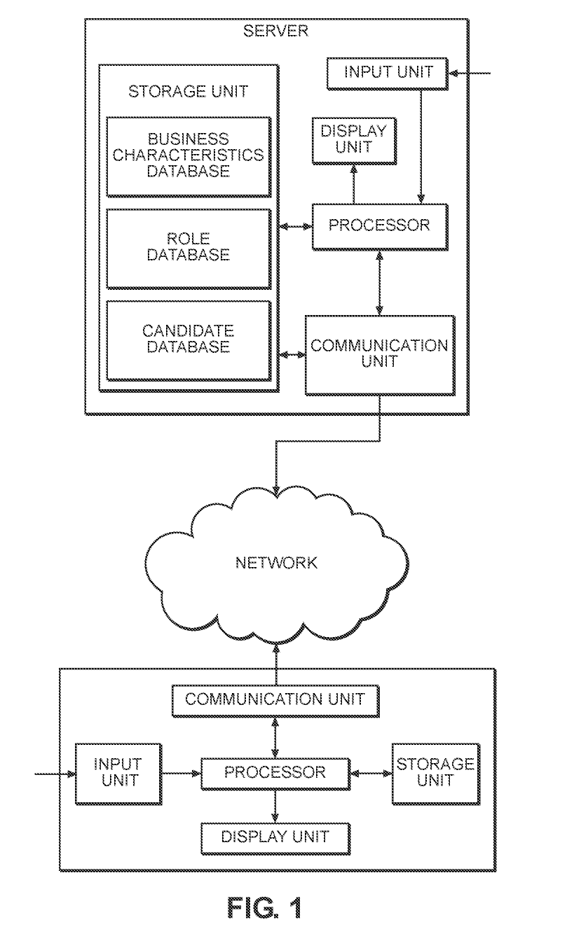

FIG. 1 illustrates a system 1000 to hire, maintain, and predict elements of employees, according to an exemplary embodiment of the present general inventive concept.

The system 1000 may include a server 100, an apparatus 200, and a network 300.

The server 100 may include an input unit 110, a display unit 120, a processor 130, a communication unit 140, and a storage unit 150.

The input unit 110 may include a keyboard, a touchpad, a mouse, a trackball, a stylus, a voice recognition unit, a visual data reader, a camera, a wireless device reader, and a holographic input unit.

The display unit 120 may include a plasma screen, an LCD screen, a light emitting diode (LED) screen, an organic LED (OLED) screen, a computer monitor, a hologram output unit, a sound outputting unit, or any other type of device that visually or aurally displays data.

The processor 130 (or central processing unit, CPU) may include electronic circuitry to carry out instructions of a computer program by performing basic arithmetic, logical, control and input/output (I/O) operations specified by the instructions. The processor 130 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 130 may also include a microprocessor and a microcontroller.

The communication unit 140 may include a device capable of wireless or wired communication between other wireless or wired devices via at least one of Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 150 may include a random access memory (RAM), a read-only memory (ROM), a hard disk, a flash drive, a database connected to the Internet, cloud-based storage, Internet-based storage, or any other type of storage unit.

The storage unit 150 of the server 100 may store any and all database information described above. More specifically, the storage unit 150 may store business characteristics of a company as first data, job roles of the company as second data, and candidate data as third data.

As such, the storage unit 150 may include a business characteristics database 151, a job role database 152, and a candidate database 153.

A user may input the above data via the input unit 110 of the server 100.

The processor 130 of the server 100 may analyze the third data based on a subset of data including at least a portion of the first data merged with at least a portion of the second data. More specifically, various data elements in the first data may converge and associate (e.g., merge) with various data elements in the second data, in order to generate a new subset of data. Then, the processor 130 may analyze the third data with the new subset of data, in order to determine whether a particular candidate is a compatible hire for the company or to generate a customized questionnaire or to generate information useful for interviewing efforts in real-time or to recommend rejection letter contents or to recommend actions to take to improve employee retention or to provide salary and negotiation recommendations. The result of the analysis may be output from the processor 130 to the display unit 120 of the server 100 to be displayed thereon, or alternatively, may be output from the processor 130 to the communication unit 140 of the server to be transmitted to another external and/or internal device or apparatus. Any generation of data may be performed autonomously by the server 100.

The apparatus may include an input unit 210, display unit 220, a processor 230, a communication unit 240, and a storage unit 250.

The input unit 210 may include a keyboard, a touchpad, a mouse, a trackball, a stylus, a voice recognition unit, a visual data reader, a camera, a wireless device reader, and a holographic input unit.

The display unit 220 may include a plasma screen, an LCD screen, a light emitting diode (LED) screen, an organic LED (OLED) screen, a computer monitor, a hologram output unit, a sound outputting unit, or any other type of device that visually or aurally displays data.

The processor 230 (or central processing unit, CPU) may include electronic circuitry to carry out instructions of a computer program by performing basic arithmetic, logical, control and input/output (I/O) operations specified by the instructions. The processor 230 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 230 may also include a microprocessor and a microcontroller.

The communication unit 240 may include a device capable of wireless or wired communication between other wireless or wired devices via at least one of Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 250 may include a random access memory (RAM), a read-only memory (ROM), a hard disk, a flash drive, a database connected to the Internet, cloud-based storage, Internet-based storage, or any other type of storage unit.

The apparatus 200 may receive the third data from a candidate's or other user's direct input into the input unit 210 of the apparatus 200. The third data may be stored in the storage unit 250 of the apparatus 200, and then sent to the server 100 via the communication unit 240 of the apparatus 200. The third data is analyzed by the server 100 and then sent back to the apparatus 200 to be displayed by the display unit 220 of the apparatus 200. All of the above actions may be controlled by the processor 230 of the apparatus 200.

Communication between the server 100 and the apparatus 200 may occur via any type of wireless network 300, including the Internet, an Intranet, intra-office connections, or inter-office connections.

Any of the outputs generated by the server 100 may be displayed on the display unit 120 of the server 100 or the display unit 220 of the apparatus 200. Likewise, any of the outputs generated by the apparatus 200 may be displayed on the on the display unit 120 of the server 100 or the display unit 220 of the apparatus 200.

The HST may be implemented within the system 1000, or as a part of the system 1000, as described below.

The Hiring Support Tool (HST) Defined as a Three-Phase Process:

Phase 1.—Setup/Client Onboarding

The Setup and Client Onboarding phase is generally a one-time step (with occasional updates/adjustments) that is performed to gather information and to setup the system 1000 before it can enter an operational phase.

During this step, use the Mind Map generation protocols (including but not limited to conducting a small number of quick, open-ended interviews with relevant management/personnel and/or ingesting documents) to generate Mind Maps necessary for the operation of the HST.

In particular, an administrator need to collect information to create Mind Maps covering at least the Client's/Company's overall business characteristics, including, but not limited to:

a) Employees: Make a list of people that the company often hires. Discover the conceptual frameworks used by those people to view the world, and, ultimately, make decisions and represent these in a proprietary format. For example, what are typical candidates' psychological, cultural, and other backgrounds?

b) Company: Build Mind Maps containing concepts covering the company's market, business environment, internal company culture, and other relevant company-related concepts. What is Hirers' core value proposition?

c) Products: Build Mind Maps describing what the company sells and how the presence of the company's products in the customers' lives affects those customers (i.e. when I have this XYZCorp security system, I can sleep more soundly in the knowledge that I will be alerted if anyone tries to break into my home and thus I will be more secure than I otherwise would. Being secure means that I can worry less and that the welfare of me and my family is likely to be enhanced.)

d) Customers: What is the conceptual makeup of the worldviews of the company's customers? From a contextual perspective, what concepts do we need to take into account to best understand these customers? What concerns them? What are their goals? How does the company facilitate or hinder their goals? What are their psychological, cultural, and other backgrounds? As always, represent all this in a proprietary format.

e) Sales and Other Key Business Process: How do the Hirers sell? What other relevant business processes do we need to take into account, especially those that potential employees would be involved in? Knowledge of current processes enables us to discover who would be a good fit for those processes.

f) Ideal Candidates: Do Hirers have thoughts on what attributes have been useful for hiring candidates in the past?

Once generated, in an exemplary embodiment, these Mind Maps may be stored in the MMDB, which may be stored within the storage unit 150 of the server 100.

Optionally, in this phase, if the Hirers have an existing Applicant Tracking System (ATS) and/or similar software that collects resumes and/or manages applicants throughout the hiring process, this material may be integrated within the HST and the system 100 (via ATS-provided interfaces if available) in order to lessen the need for the Hirers to manually upload candidate data/documents into the system. Also, Excel spreadsheets or candidate databases, etc. that the Hirers may be using (that is, other than an ATS or similar software) may be integrated with the HST and the system 1000.

In one embodiment, the HST can host one or more email addresses which are inserted into job descriptions. When emails are received on one of these addresses, the HST can automatically process them and add candidates into the workflow/update data. In one embodiment, the HST can receive candidate information via email.

Subsequently, specific job roles for which the Hirers wish to hire candidates may be set up. In a preferred embodiment, these specific job roles may be stored in the form of Role Profiles (RP) stored in the RDB. RPs contain at a minimum:

a) the business/mission outcomes Hirers want the role to achieve,

b) optionally, the personal/professional attributes Hirers think the person filling the role should bring (note: we ‘take this with a grain of salt’, as it's easy to introduce bias in this way and we want the simulations to be the main source of intelligence here),

c) optionally, any template job descriptions (JD) that may be available. These can be stored in natural language format, or any other convenient format.

If JDs are introduced into the system, a combination of manual input and computer-based processing is used to convert these JDs into a predetermined proprietary format. Doing so facilitates allowing the content embedded in the JDs to contribute significantly to the simulation process and/or the system suggesting JD content.

Once all of the preceding information has been generated by/presented to/retrieved by the HST, the HST will then combine that information and run a simulation to discover the optimal content for the actual JD that will be advertised for the position. The system 100 may essentially answer questions including but not limited to the following: given the outcomes we want to achieve for the Hirers, what candidate attributes are desirable, and what messages will be most attractive to the right candidate and less attractive to the wrong candidate, where right/wrong are defined as candidates likely to function well in the Hirers' environment and make the desired impact. In an exemplary embodiment, those messages will then be packaged up into recommendations and delivered to the Hirers via the SDa.

Once Hirers accept or reject any specific recommendations the system 1000 makes, it will use Natural Language Generation and/or other technologies to help generate a final JD. The requirements put forth in the JD will be part of what the system 1000 takes into account when recommending candidates—in other words, it will generally assume that potential candidates are at least somewhat likely to have seen the JD. Note that, unless and until automated JD extraction technology is added to the system 1000, any changes to the JD made by Hirers after the Final JD is generated will not be taken into account unless Hirers go back into the SDa and update the data which drives the representation of the JD. It may be ideal to tell the HST everything that is desired evaluate candidates as fairly as possible. Such automated JD extraction technology could readily be provided via various technologies.

Once the HST has the preceding information, it will automatically build and/or recommend elements for a custom questionnaire used as the first step in evaluating candidates.

In one exemplary embodiment, it does this by computing a base set of concepts that the HST would most like to use to evaluate candidates for specific roles. Drawing on a base set of questions, it adapts these to those concepts and then generates the questionnaire from these. Other processes for could also be used.

Any generation of data may be performed autonomously by the HST.

Phase 2: Operational Phase (Deployment)

In a preferred embodiment, whenever a new applicant enters a workflow, the following steps may occur:

1. The system sends the applicant an email directing them to complete the Hirers-customized questionnaire and to upload their resume, cover letter, qualifications, references, recommendations, etc. directly into the HST over the Internet (using their browser) via the Network 300. If the email import feature is present and enabled, this email may also include directions on how to accomplish this.

2. The applicant sends information to the HST. The HST may also retrieve further third party content, including but not limited to social media and public records.

3. The HST converts the questionnaire results and/or other information into proprietary formats, other convenient formats, and/or a combination thereof. It then runs a simulation of how the particular candidate at hand will fit/function within Hirers' context. The outcome of the simulation is converted into an interview/no-interview decision. The HST then sends its recommendation to Hirers (together with an explanation, which may be expressed in ‘Fishbone Diagram’ and/or other formats). By responding to an automatically-generated email and/or interacting with the SDa, Hirers choose to accept or override the system's recommendation. If Hirers choose to override it, the system collects information on why this is happening so it can learn and be smarter in future. If the applicant is rejected, the HST sends an email (i.e., letter of rejection) to the applicant tailored to the applicant's personality (so as to reduce ill will generated to the extent possible). If the applicant is accepted, the system 1000 works with the applicant to help schedule dates and times for calls/face-to-face meetings, and can generate an email (i.e., letter of acceptance).

4. If an interview is held, during the interview, a part of the SDa provides a tool that the interviewer can use in real time. It provides hints to the interviewer about what topics to bring up next, highlights interesting/problematic aspects of the employee's background, and provides space for the interviewer to take notes. As the interview progresses, the interviewer can click concepts that are covered, rate the candidate on those concepts, and give the system 1000 new concepts to add to the interview, generating a two-way real-time interactive dialogue between interviewer and the SDa intended to maximize the usefulness of the interview.

5. After the interview, the system 1000 can give salary and negotiation recommendations based on the personality of the candidate. Again, these can be delivered via the SDa.

(Optional) Phase 3: Current Employee Testing Mode

Once the HST has been loaded with the data described above, the system 1000 can be used in a mode whereby Hirers' data and/or other data is used by the HST to compute metrics related to existing employees' state of mind, including levels of engagement, emotional state, likelihood of leaving the company, likelihood of creating security threats, whether they are happy in their current job, whether they are thinking about quitting, whether they are bored, whether they feel safe at work, and so on. The HST may also retrieve further third party content, including but not limited to social media and public records.

The HST may use any or all of the above information to help make a determination as to whether the employee is an “at risk” employee (i.e., the employee could cause inefficiency, low-productivity, financial losses, or danger for the company, but may also include other risk factors such as desiring to quit, etc.). The HST can use simulation to determine the severity of any particular aspect of this and recommend steps to be taken to improve the situation and/or protect Hirers/Hirers' institution. In one embodiment, existing employees may be encouraged to fill out a special questionnaire that enables the HST to compute their level of engagement. Gift certificates or other rewards can be given in exchange for filling out the questionnaire, and the HST should be able to determine whether or not employees are seriously filling out the form or simply going through the motions by analyzing the variability and consistency of responses.

This questionnaire can be generated by processes similar to those described above with respect to the initial questionnaire generation. In another embodiment, the system 1000 can ingest existing data that Hirers have access to.

The SDa can provide information on and/or highlight employees that may be at risk and use simulation to suggest interventions that may be of use in ameliorating the situation.

Public records, social media (e.g., FACEBOOK, MYSPACE, LINKEDIN, TWITTER, etc.), and other information outside the system 1000 may be accessed by the HST to monitor employees' behaviors and propensities, or alternatively, to gather more data on a candidate prior to the hiring of the candidate.

The system 1000 can be linked to system(s)/server(s) in order to extract information regarding employee performance, material costs, day-to-day activities/results, and other company data, in order to try to prevent employees from under-performing or performing poorly. This would potentially avoid firings and lay-offs in the future, thereby cutting on costs of rehiring, retraining, and payment of unemployment benefits.

Furthermore, the system can be adapted to allow the company to input private company data directly into the system, in order to allow the system to utilize more data to make its determinations and outputs. In other words, the system will be able to track everything regarding the company, in order to maximize productivity while minimizing costs.

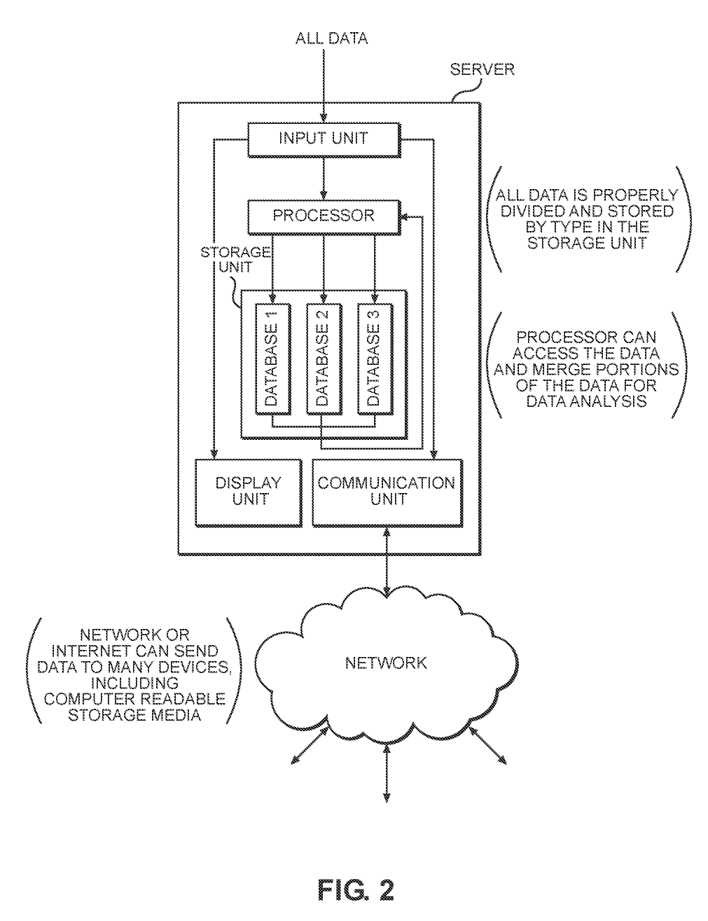

It is important to note that although FIGS. 1 and 2 illustrate components in plurality, such as three databases, the present general inventive concept is not limited thereto, and therefore, components of the present general inventive concept may be provided in singular or plural form. Accordingly, the present general inventive concept is not limited to three databases, and may alternatively include one, two, more than three databases, or even no databases, based on a user's preferences.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system to predict whether a candidate is a compatible hire for an entity, the system comprising:
a server to store first data corresponding to business characteristics of the entity and second data corresponding to job roles of the entity; and
an apparatus to receive third data corresponding to the candidate and to transmit the third data to the server, such that the server analyzes the third data based on a subset of data comprising at least a portion of the first data merged with at least a portion of the second data, and the server outputs a prediction as to whether the candidate is a compatible hire for the company based on the analysis.

2. The system of claim 1, wherein the apparatus further comprises:
an input unit to allow a user to input the third data; and
a display unit to display the prediction to the user.

3. The system of claim 2, wherein the apparatus further comprises:
a communication unit to transmit the third data to and from the server.

4. The system of claim 3, wherein the user may input the first data and the second data via the input unit to allow the communication unit to transmit the first data and the second data to the server.

5. The system of claim 2, wherein the input unit comprises at least one of a keyboard, a touchpad, a mouse, a trackball, a stylus, a voice recognition unit, a visual data reader, a camera, a wireless device reader, and a holographic input unit.

6. The system of claim 2, wherein the communication unit comprises a device capable of wireless or wired communication between other wireless or wired devices via at least one of Wi-fi, Wi-fi direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

7. The system of claim 1, wherein the server stores the third data.

8. The system of claim 7, wherein the server analyzes another subset of data comprising at least a portion of the first data merged with at least a portion of the second data and at least a portion of the third data, and outputs a letter of rejection or a letter of acceptance based on the analysis of the another subset of data.

9. The system of claim 1, wherein the server generates a questionnaire based on the subset of data to allow the candidate to input answers into the questionnaire to be merged with the third data.

10. The system of claim 1, wherein the server generates a job description based on the subset of data.

11. The system of claim 1, wherein when the candidate is a hired employee, the server outputs risk data to indicate that action should be taken to alleviate any risks associated with the candidate.

12. The system of claim 1, wherein the third data is based on at least one of information input by a user and other information autonomously retrieved by the processor.

13. A server to predict whether a candidate is a compatible hire for a company, the server comprising:
a storage unit to store first data corresponding to business characteristics of the company, second data corresponding to job roles of the company, and third data corresponding to the candidate; and
a processor to analyze the third data based on a subset of data comprising at least a portion of the first data merged with at least a portion of the second data, and to output a prediction as to whether the candidate is a compatible hire for the company based on the analysis.

14. The system of claim 13, wherein the third data is based on at least one of information input by a user and other information autonomously retrieved by the processor.

15. A server to determine whether an employee of a company is at risk, the system comprising:
a storage unit to store at least one set of data; and
a processor to analyze the set of data based on at least one of predetermined criteria, generated criteria, and retrieved criteria to determine whether the employee is considered to be at risk.

16. The server of claim 15, wherein the predetermined criteria comprises at least one of a level of engagement of the employee in the company, an emotional state of the employee, likelihood of the employee leaving the company, likelihood of the employee creating security threats, whether the employee is happy in a current position, whether the employee is thinking about quitting, whether the employee is bored, and whether the employee feels safe at work.

17. The system of claim 15, wherein the at least one set of data is based on at least one of information input by a user and other information autonomously retrieved by the processor.

18. A method of predicting whether a candidate is a compatible hire for a company, the method comprising:
storing first data in a storage unit of a server, the first data corresponding to business characteristics of the company;
storing second data in the storage unit of the server, the second data corresponding to job roles of the company;
receiving third data in the server, the third data corresponding to the candidate;
analyzing the third data based on a subset of data comprising at least a portion of the first data merged with at least a portion of the second data; and
outputting a prediction as to whether the candidate is a compatible hire for the company based on the analysis.

19. A method of determining whether an employee of a company is at risk, the method comprising:
storing at least one set of data; and
analyzing the set of data based on at least one of predetermined criteria, generated criteria, and retrieved criteria, to determine whether the employee is considered to be at risk.

20. A system to predict whether a candidate is a compatible hire for a company, the system comprising:
a storage unit to store at least one set of data; and
a processor to analyze the set of data based on at least one of predetermined criteria, generated criteria, and retrieved criteria, to determine whether the employee is considered to be a compatible hire for the company.

21. The system of claim 20, wherein the at least one set of data is based on at least one of information input by a user and other information autonomously retrieved by the processor.
